(19) United States
(12) Patent Application Publication
(10) Pub. No.: US 2008/0170073 A1
(43) Pub. Date: Jul. 17, 2008

(54) Computer-readable recording medium having system analysis program stored therein, system analysis method, and system analysis apparatus

(75) Inventors: Miyuki Ono, Kawasaki (JP); Kouichi Kumon, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/008,207

(22) Filed: Jan. 9, 2008

(30) Foreign Application Priority Data
Jan. 17, 2007 (JP) 2007-8471

(51) Int. Cl. G06T 11/20

(52) U.S. Cl. 345/440.1

(57) ABSTRACT

A system analysis apparatus acquires time series data representing information on a series of processes executed in a computer system in a time-serial manner. A run table shows the ratio of the number of runs of each process to the total number of processes executed in a predetermined unit time in a time-serial manner. A first graph is displayed representing ratios of a series of processes which has been executed in a time-serial manner by collecting the ratio of each process stored in the run table. A moving average of the ratio of each process is calculated by referring to the run table when a parameter change for the first graph is accepted. A second graph is displayed representing the ratios of the series of processes executed by collecting the moving average of each process.

### TECHNICAL FIELD

The present invention relates to the field of techniques involving performance analysis of computer systems.

### SUMMARY

According to an aspect of an embodiment of the present invention, a system analysis apparatus has an acquisition unit for acquiring time series data representing information on a series of processes which has been executed in a computer system in a time-serial manner. A creation unit creates a run table showing the ratio of the number of runs of each process to the total number of processes executed in a predetermined unit time in a time-serial manner, based on the time series data acquired in the acquisition step. A display unit displays on a display screen a first graph representing ratios of a series of processes which has been executed in the computer system in a time-serial manner by collecting the ratio of each process stored in the run table created by the creation unit. An accepting unit accepts a display change instruction for the first graph as a result of the display of the first graph by the display unit; and a moving average calculation unit calculates a moving average of the ratio of each process by referring to the run table created by the creation unit when the display change instruction for the first graph is accepted by the accepting unit. The display unit then displays on the display screen a second graph representing the ratios of the series of processes which has been executed in the computer system in a time-serial manner by collecting the moving average of each process calculated by the moving average calculation unit.

### BRIEF DESCRIPTION OF THE DRAWINGS

FIG. 1 is an illustration showing a hardware configuration of a system analysis apparatus according to an embodiment of the invention;

FIG. 2 is an illustration showing contents stored in a profiling data DB;

FIG. 3 is a block diagram showing a functional configuration of the system analysis apparatus according to the embodiment of the invention;

FIG. 4 is an illustration schematically showing a run table creating process;

FIG. 5 is illustrations showing specific examples of a first graph;

FIG. 6 is an illustration showing an example of a display change instruction screen;

FIG. 7 is an illustration showing an example of a calculation type selection screen;

FIG. 8 is an illustration schematically showing a moving average calculation process;

FIG. 9 is an illustration showing a specific example (Example 1) of a second graph;

FIG. 10 is an illustration schematically showing a weighting process;

FIG. 11 is an illustration showing an example of a condition specifying screen;

FIG. 12 is an illustration showing a specific example (Example 2) of the second graph;

FIG. 13 is an illustration showing a specific example (Example 3) of the second graph;

FIG. 14 is an illustration showing a specific example (Example 4) of the second graph; and

FIG. 15 is a flow chart showing steps of a system analyzing process performed by the system analysis apparatus according to the embodiment of the invention.

### DETAILED DESCRIPTION OF THE EMBODIMENT

In a computer system, troubles and degradation of performance may occur in a time-serial manner during the execution of an application. For example, a daemon process may be periodically activated by a human error irrespective of the user's intention, which can degrade the performance of the computer system. In order to find causes of such a phenomenon, it is necessary to trace the behavior of the computer system accurately from profiling data acquired in a time-serial manner.

For example, the profiling data must be acquired every few milliseconds to trace the activation of the daemon process and the behavior of the application accurately. However, it has been difficult to obtain information useful for performance analysis using an existing function profiler (e.g., gprof) for reasons such as a high overhead of measurement.

Under the circumstance, there are demands for an analyzing technique for tracing the behavior of a computer system with high efficiency and accuracy. For example, a technique has been proposed, in which profiling data are acquired at constant time intervals and collected in certain unit times to re-calculate the breakdown of execution times of functions. For example, such a technique is disclosed in Shuji Yamamura, System Analysis Method by Statistical Analysis on Time-Series Data for a PC Cluster System, IPSJ Transaction Vol. 47, No. SIG12 (ACS15) pp. 250-261 (2006).

Specifically, the ratio of each function acquired at a certain point in time is calculated. For example, when two functions are acquired in the same ratio at that point in time, it is assumed that the execution time of each function has a 50% share. By identifying a breakdown of the execution time of each function at each point in time as thus described, it is possible to know what types of programs have operated in what degrees in which time slot.

However, according to the above-described technique in the related art, depending on the unit time used for collecting profiling data acquired, the breakdown of the execution time of each function can vary, and the behavior of a program can appear differently. A problem has consequently arisen in that the behavior of a program cannot be properly traced.

Specifically, when the unit time used for collecting profiling data is short, the number of data to be used for re-calculating the breakdown of execution times of functions is too small, and there will be significant statistical variation. In this case, the behavior of a program can be represented in an exaggerated manner, and a problem has therefore arisen in that it is difficult to trace the behavior of a program accurately.

When the unit time used for collecting profiling data is long, there is a great number of data to be used for re-calculating the breakdown of execution times of functions. In this case, although statistical variation is small, the behavior of a program will be represented in a too gentle form, and a problem has therefore arisen in that it is difficult to trace the behavior of a program in detail.

As thus described, when it is attempted to analyze the behavior of a program by simply collecting profiling data in certain time units, the behavior of the program cannot be properly traced because of statistical variation. As a result, a problem has arisen in that problems such as troubles and performance degradation in a computer system cannot be accurately identified.

A preferred embodiment of the invention will now be described in detail with reference to the accompanying drawings.

(Hardware Configuration of System Analysis Apparatus)

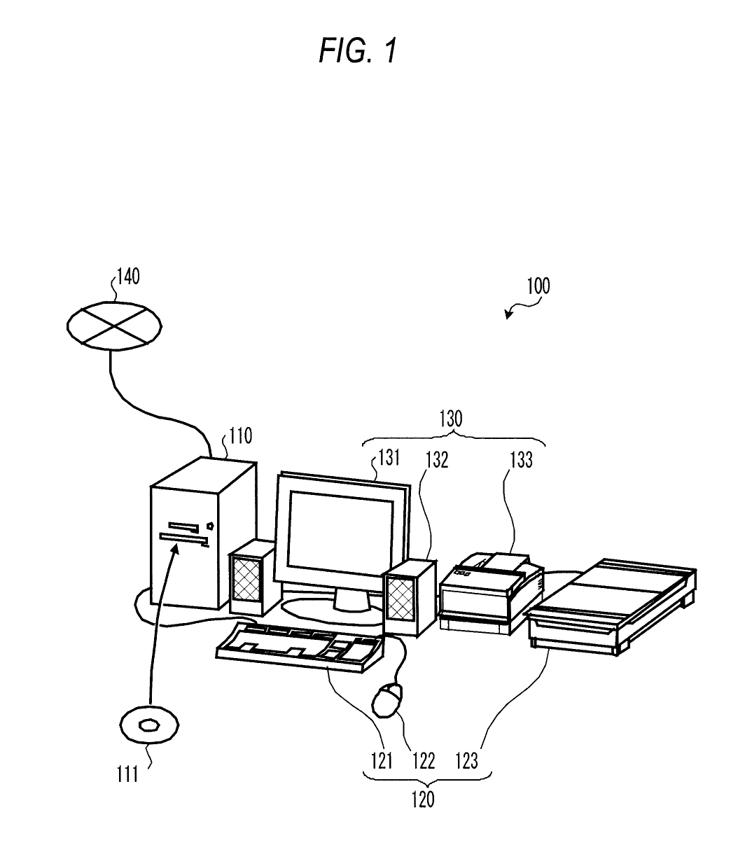

First, a hardware configuration of a system analysis apparatus 100 will be described. FIG. 1 is an illustration showing the hardware configuration of the system analysis apparatus of the present embodiment. Referring to FIG. 1, the system analysis apparatus 100 includes a computer main body 110, an input device 120, and an output device 130. The apparatus can be connected to a LAN, a WAN or a network 140 such as the internet through a router or a modem which is not shown.

The computer main body 110 includes a CPU, memories, and an interface. The CPU exercises control over the hardware configuration of the system analysis apparatus 100 as a whole. The memories include a ROM, a RAM, a hard disk, an optical disk 111, and a flash memory. The memories are used as work areas of the CPU.

Various types of programs are stored in the memories and are loaded in accordance with commands from the CPU. Data reading and writing from and in the hard disk and the optical disk 111 is controlled by a disk drive. The optical disk 111 and the flash memory are detachably mounted in the computer main body 110. The interface controls input from the input device 120, output to the output device 130, and transmission and reception to and from the network 140.

The input device 120 may include a keyboard 121, a mouse 122, and a scanner 123. The keyboard 121 has keys for inputting characters, numerals, and various instructions to allow input of data. A touch-panel type keyboard may be used.

The mouse 122 is used for moving a cursor, selecting a range, moving a window, and changing the size of a window. The scanner 123 optically reads images. A read image is acquired as image data and stored in a memory in the computer main body 110. The scanner 123 may have an OCR function.

The output device 130 may include a display 131, a speaker 132, and a printer 133. The display 131 displays a cursor, icons, and a tool box, and data such as documents, images, and information on functions are also displayed on the same. The printer 133 prints image data and document data. The speaker 132 outputs sounds such as sound effects or text-to-speech sounds.

(Contents Stored in Profiling Data DB)

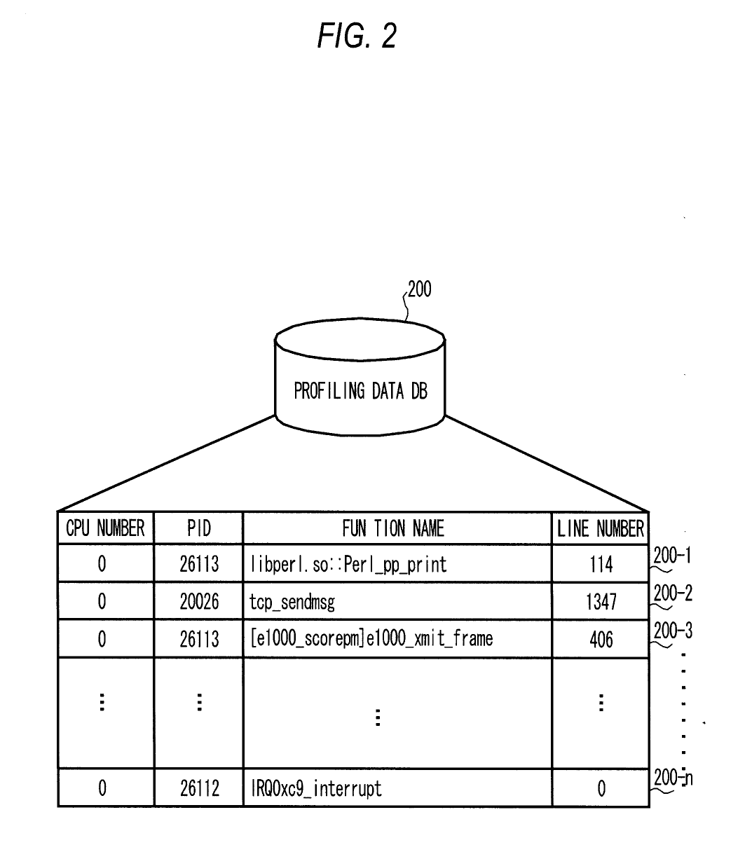

Contents stored in a profiling data DB 200 provided in the system analysis apparatus 100 will now be described. FIG. 2 is an illustration of contents stored in the profiling data DB 200. Referring to FIG. 2, profiling data 200-1 to 200-n acquired at arbitrary time intervals (e.g., intervals of 1 [ms]) are stored in the profiling data DB 200.

For example, the profiling data 200-1 to 200-n are performance data acquired by running an application to be subjected to performance analysis on the computer system and obtained from the beginning until the end of the execution of the program of interest. Each of the profiling data 200-1 to 200-n is an item of data showing a function (process) which was being executed on the computer system when it was acquired.

The profiling data 200-1 to 200-n include information on CPU numbers, PIDs, function names, and line numbers. A CPU number is an identifier for identifying a CPU which was operating when each of the profiling data 200-1 to 200-n was acquired.

A PID (process ID) is an identifier for identifying a process which was operating when each of the profiling data 200-1 to 200-n was acquired. A function name is a name of a function which was being executed when each of the profiling data 200-1 to 200-n was acquired, and a line number is a number indicating a line in a source code where such a function is described.

For example, the profiling data 200-1 indicates that a CPU having a CPU number “0” is operating to execute a process having a PID “26113”. Specifically, the data indicates that a function having a function name “libperl.so::Perl_pp_print” is being executed and that the line in the source code where the function is described has a line number “114”.

The profiling data 200-1 to 200-n stored in the profiling data DB 200 may be the entire data acquired at arbitrary time intervals during the period between the beginning and the end of a program of interest. The data may alternatively be data acquired in an arbitrary section of time during the execution of the program.

(Functional Configuration of System Analysis Apparatus)

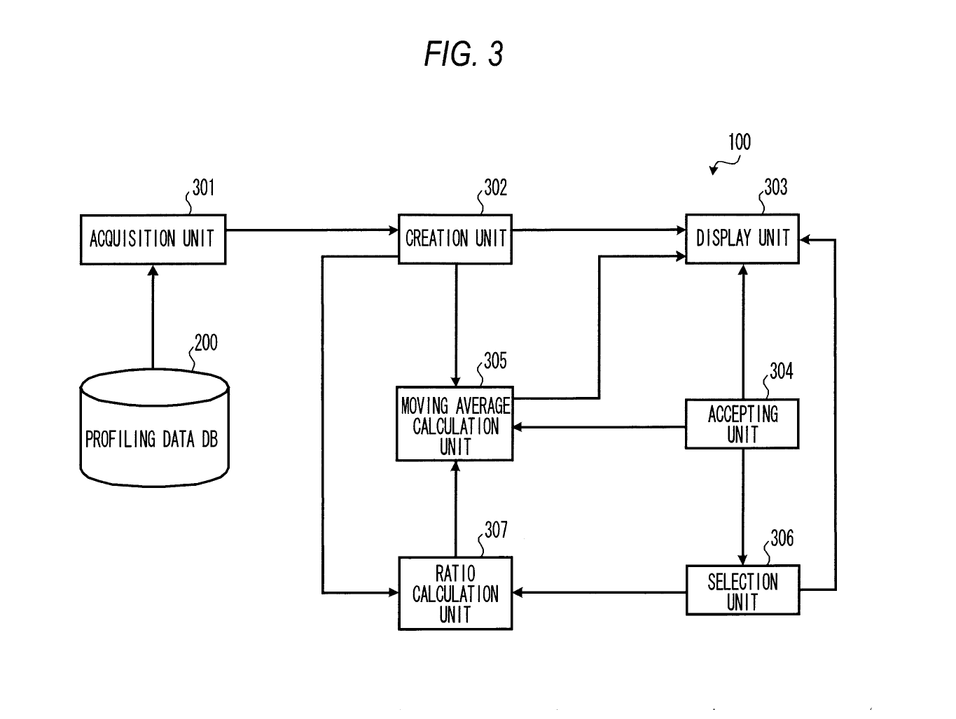

A functional configuration of the system analysis apparatus 100 of the present embodiment will now be described. FIG. 3 is a block diagram of a functional configuration of the system analysis apparatus 100 of the present embodiment. Referring to FIG. 3, the system analysis apparatus 100 includes the profiling data DB 200, an acquisition unit 301, a creation unit 302, a display unit 303, an accepting unit 304, a moving average calculation unit 305, a selection unit 306, and a ratio calculation unit 307.

First, the acquisition unit 301 has a function of acquiring time series data representing information on a series of processes which has been executed in the computer system in a time-serial manner. The computer system may be a simplex system, and it may alternatively be a computer system formed by connecting a plurality of computers through a network 140, e.g., a cluster system or grid system.

Time series data is information representing processes which have been executed in the computer system in the order of execution. For example, it is data representing information on processes, functions, or objects which have been executed in the computer system in the order of execution. Specifically, the time series data is, for example, a set of data stored in the profiling data DB 200 shown in FIG. 2.

For example, the acquisition unit 301 may acquire time series data by reading the profiling data 200-1 to 200-n from the profiling data DB 200. Alternatively, the acquisition unit 301 may acquire time series data directly input to the system analysis apparatus 100. Further, time series data may alternatively be acquired from an external computer apparatus through the network 140. The time series data acquired by the acquisition unit 301 are stored in a memory such as the ROM or RAM.

The creation unit 302 has a function of creating a run table showing the ratio of the number of runs of each process to the total number of processes executed in a predetermined unit time in a time-serial manner based on the time series data acquired by the acquisition unit 301. Specifically, the creation unit 302 reads the time series data stored in the memory such as the ROM or RAM and creates a run table based on the time series data.

The predetermined unit time is a time interval during which the ratio of each process is identified, and it may be arbitrarily set. It is assumed here that each of the profiling data 200-1 to 200-n is acquired every 1 millisecond and that the predetermined unit time is 3 milliseconds.

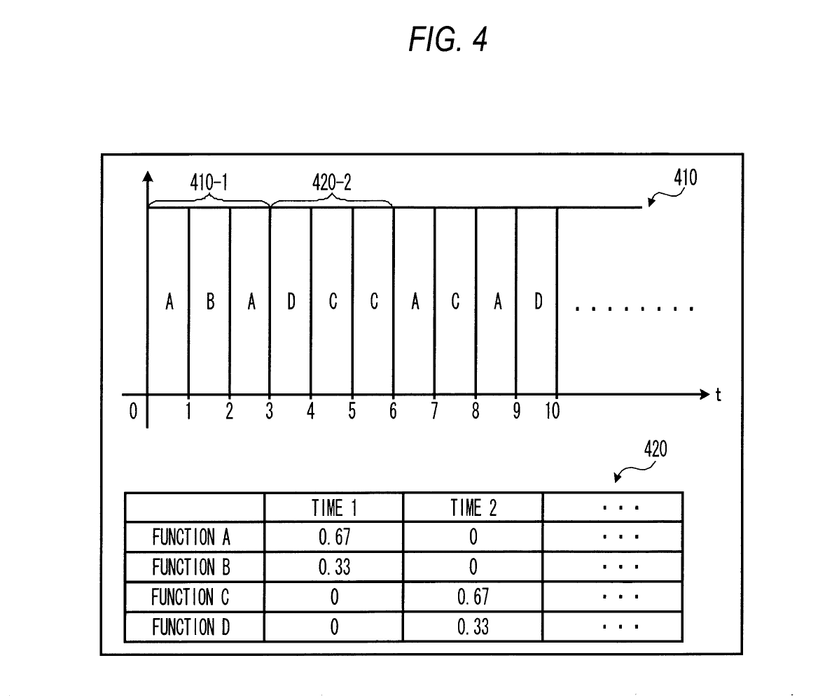

In this case, the creation unit 302 creates a run table by finding the ratio of each process each time three consecutive profiling data (e.g., the profiling data 200-1 to 200-3) are acquired. The process of creating the run table will be described later with reference to FIG. 4. The run table created by the creation unit 302 is stored in a memory such as the ROM or RAM.

The display unit 303 has a function of collecting the ratio of each process stored in the run table created by the creation unit 302 and displaying a first graph indicating ratios of a series of processes which have been executed in the computer system in a time-serial manner on the display screen. Specifically, the display unit 303 reads the run table stored in the memory such as the RAM or ROM and displays a first graph that is based on the run table on the display 131.

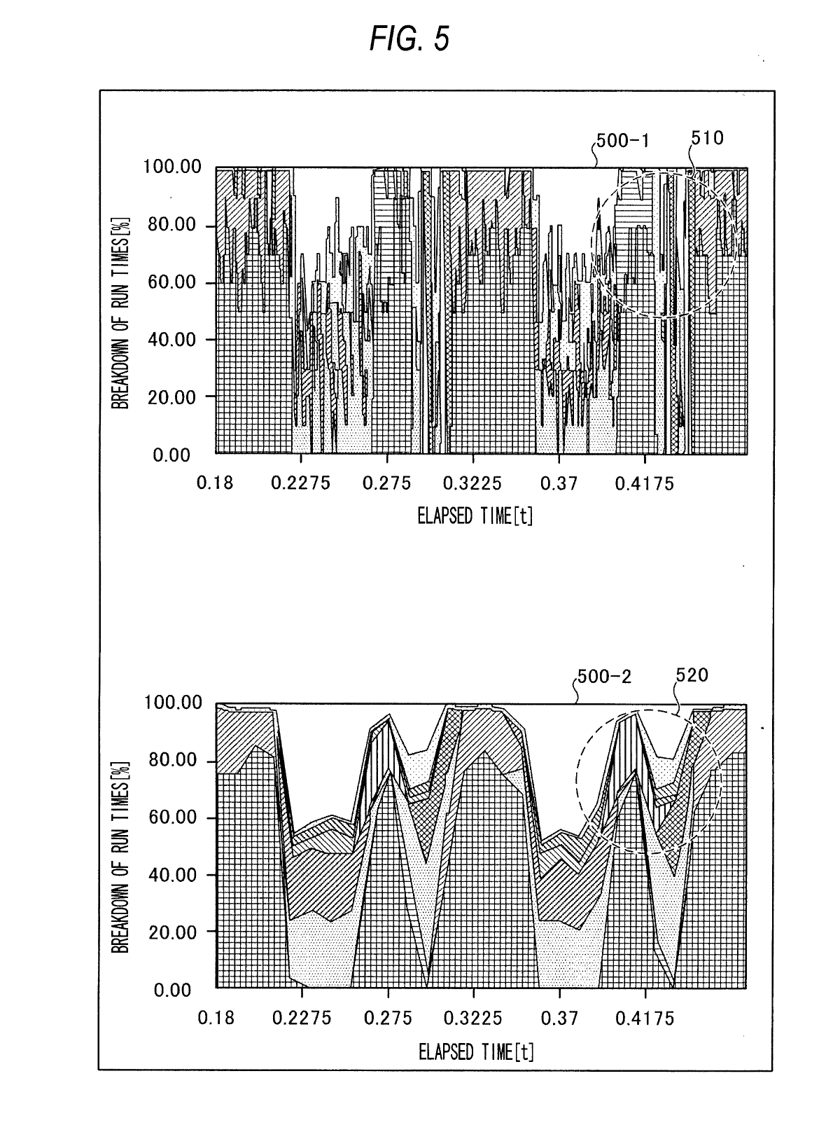

More specifically, the breakdown of the execution time of each process at each point in time is calculated based on the ratio of each process stored in the run table. The breakdown of the execution time of each process thus calculated is collected to generate the first graph, and the graph is displayed by the display unit 303 on the display 131. The first graph displayed by the display unit 303 will be described later with reference to FIG. 5.

The first graph displayed on the display 131 may be a graph showing a breakdown of execution times of all processes which have been executed in the computer system or a graph showing particular processes only, e.g., showing only ten processes ranked high in the order of the shares in the breakdown of execution times. Specifically, a calculated breakdown of the execution time of each process is sorted to create a graph showing ten processes which are ranked high in the order of shares in the breakdown of execution times.

The accepting unit 304 has a function of accepting an instruction for a change in the display of the first graph when the first graph is displayed by the display unit 303. Such a display change instruction is input when a user determines that the behavior of a program which has been executed in the computer system cannot be properly traced because of significant statistical variation of the breakdown of the execution time of each process represented by the first graph.

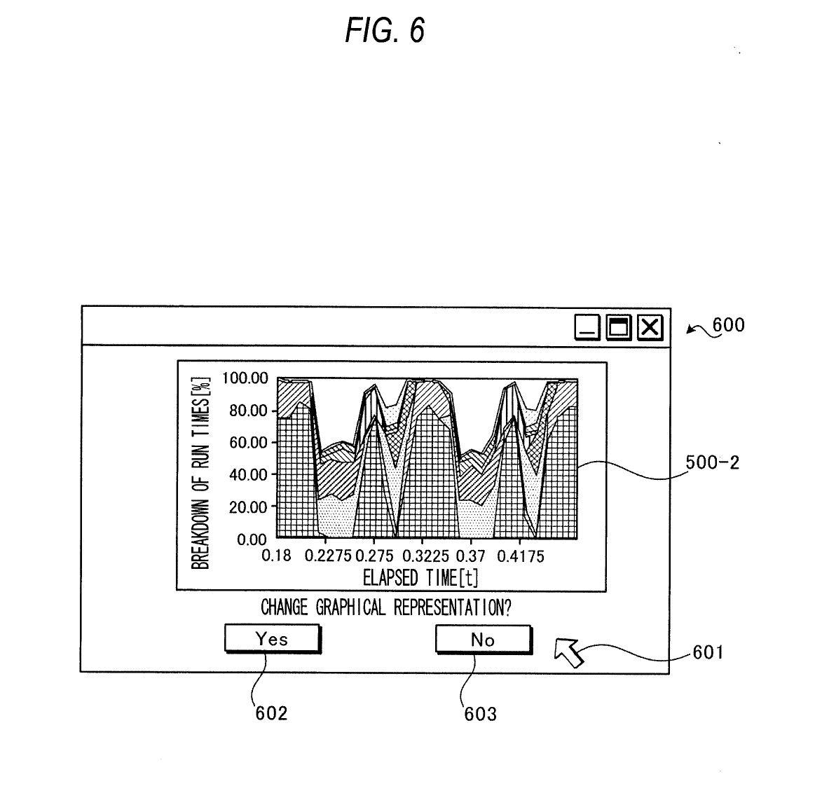

Specifically, a user inputs a display change instruction for the first graph by, for example, operating the input device 120 such as the keyboard 121 or the mouse 122. The input of a display change instruction for the first graph will be described later with reference to FIG. 6.

The moving average calculation unit 305 has a function of calculating a moving average of the ratio of each process by referring to the run table created by creation unit 302 when a display change instruction for the first graph is accepted by the accepting unit 304.

Specifically, the moving average calculation unit 305 reads the run table stored in the memory such as the ROM or RAM and calculates a moving average by referring to the run table. A moving average calculated by the moving average calculation unit 305 is stored in a memory such as the RAM or ROM.

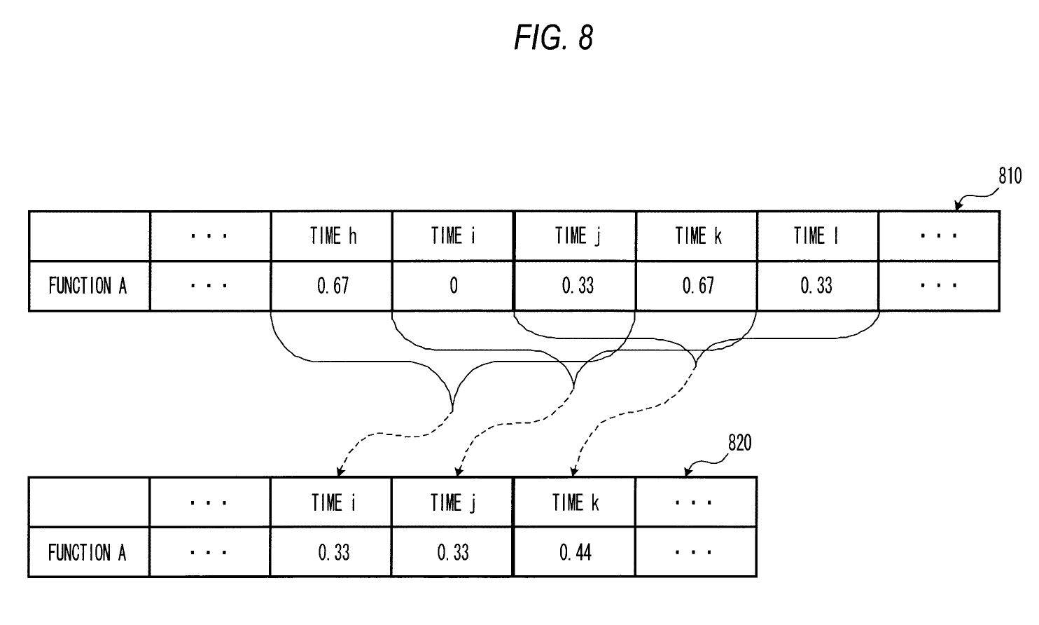

Moving averaging is a process of calculating an average value of original data from a value of the data at each point in time within a predetermined period of time. For example, let us assume that the predetermined time period is 3 milliseconds and that the points in time are a, b, c, and d coming in the order listed at intervals of 1 millisecond. Then, an average of values obtained at the times a, b, and c constitutes a moving average at the time b. The process of calculating moving averages will be described later with reference to FIG. 8.

The use of moving averaging on the ratio of each process stored in the run table makes it easier to find the basic tendency of the ratio of each process. Specifically, the ratio of each process is obtained in a statistical manner from values observed in predetermined periods of time in an overlapping relationship instead of identifying the ratio of each process in an exclusive manner, which makes it possible to obtain a smooth and accurate representation of behaviors of a program.

The display unit 303 has a function of collecting moving averages of each process calculated by the moving average calculation unit 305 and displaying a second graph indicating ratios of a series of processes which have been executed in the computer system in a time-serial manner on the display screen. Specifically, the display unit 303 reads the moving averages stored in the memory such as the RAM or ROM and displays the second graph that is based on the moving averages on the display 131.

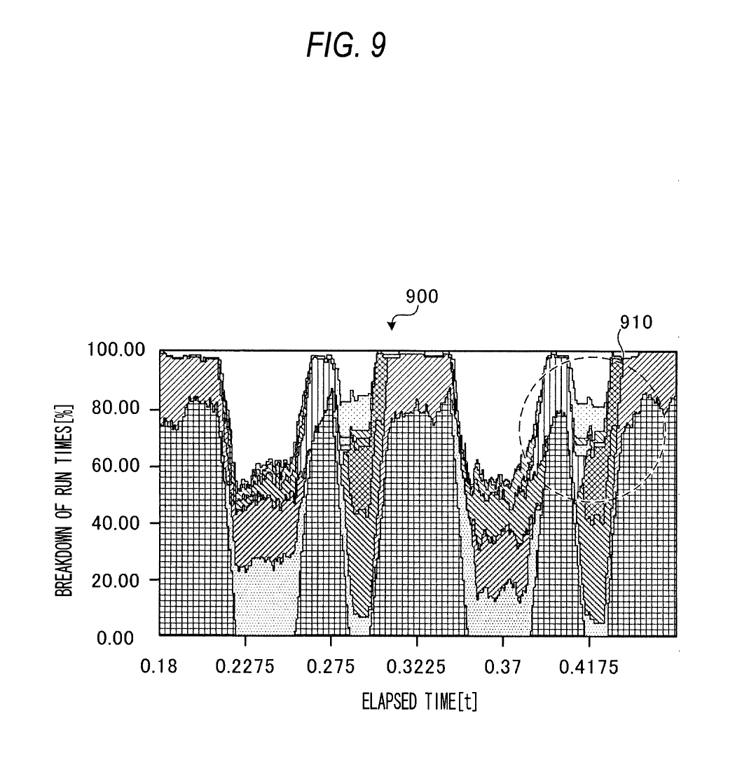

More specifically, the breakdown of the execution time of each process at each point in time is calculated based on a moving average of the ratio of each process. The breakdown of the execution time of each process thus calculated is collected to generate the second graph, and the graph is displayed by the display unit 303 on the display 131. The second graph displayed by the display unit 303 will be described later with reference to FIG. 9.

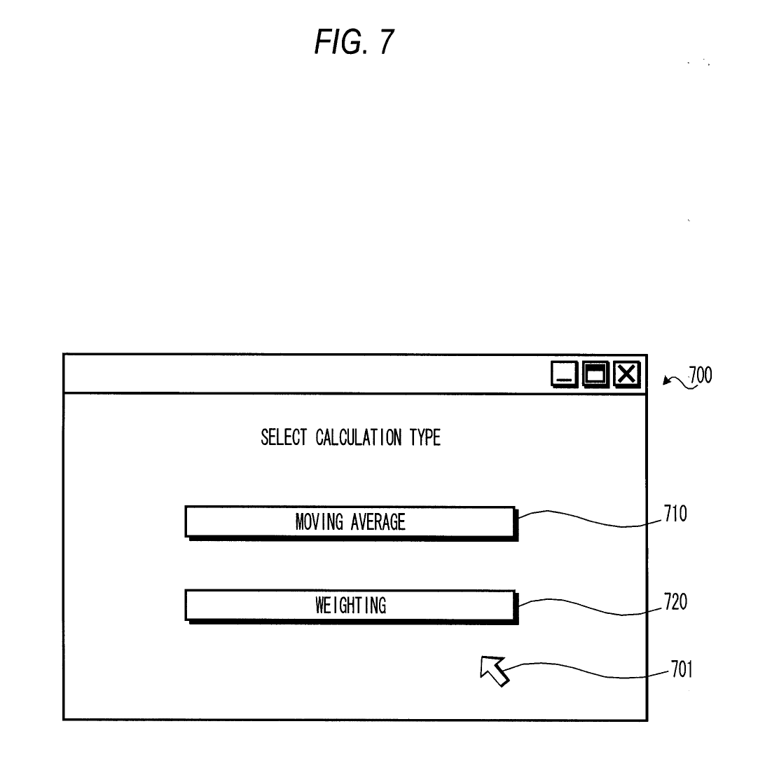

The selection unit 306 has a function of accepting selection on whether to weight the ratio of each process or not when a display change instruction for the first graph is accepted by the accepting unit 304. A user inputs the selection on whether to weight or not by, for example, operating the input device 120 such as the keyboard 121 or the mouse 122. The input of selection on whether to weight or not will be described later with reference to FIG. 7.

The selection unit 306 also has a function of accepting selection of a window function for weighting the ratio of each process from among a plurality of window functions when selection to weight the ratio of each process is accepted. A window function is a function that is zero-valued outside of a finite interval. The ratio of each process may be multiplied by such a window function to weight each ratio. At this time, since the function is zero-valued outside of a finite interval, a numerical analysis on the ratio of each process is facilitated because only the finite interval is left.

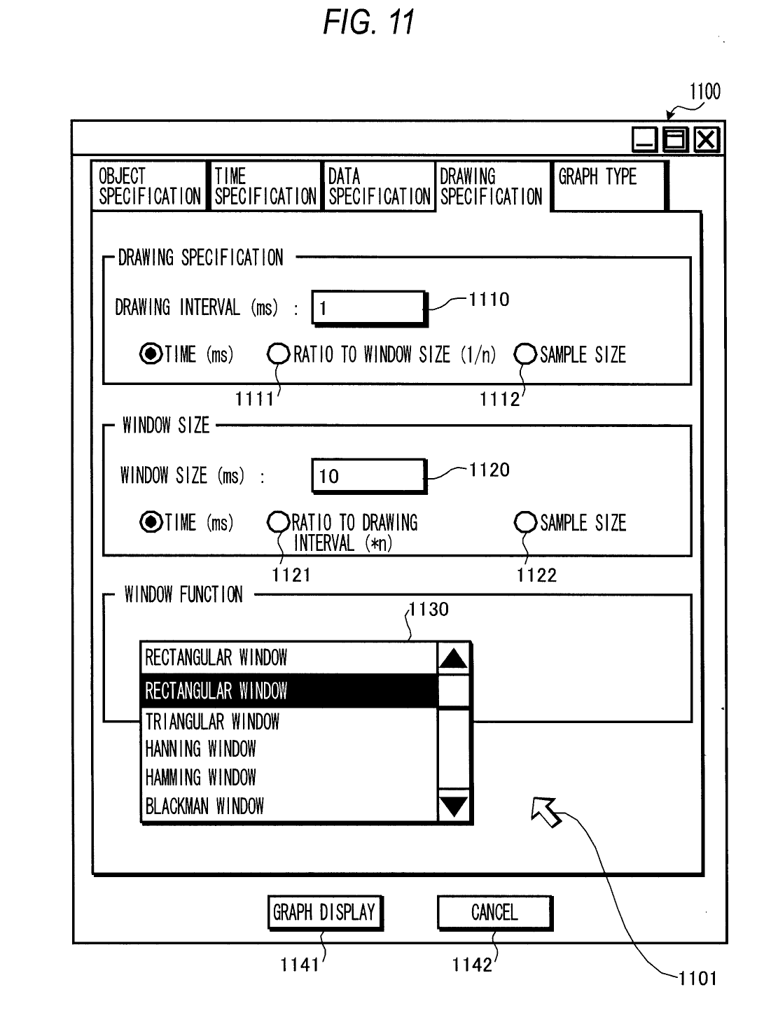

The selection unit 306 further has a function of accepting selection of a range over which multiplication by a window function is to be performed for the ratio of each process. A range for multiplication by a window function is a range over which weighting is performed through multiplication by a window function. For example, a user inputs selection of a window function and a range to apply the window function by operating the input device 120 such as the keyboard 121 or the mouse 122. The selection of a window function and a range to apply the window function will be described later with reference to FIG. 11.

The ratio calculation unit 307 has a function of calculating a weighted ratio of each process by multiplying the ratio of each process by a window function selected by the selection unit 306. The ratio calculation unit 307 has a function of calculating a weighted ratio of each process by multiplying the ratio of each process by a window function based on a range selected by the selection unit 306.

Window functions for weighting the ratio of each process will now be described. For example, a triangular window, Hanning window, Hamming window, or Blackman window may be used as a window function. The window functions are represented by Expressions (1) to (4) shown below, respectively.

Triangular window: w(x)=1−2××|x−0.5| Exp. 1

Hanning window: w(x)=0.5−0.5×cos(2πx) Exp. 2

Hamming window: w(x)=0.54−0.46×cos(2πx) Exp. 3

Blackman window: w(x)=0.42−0.5×cos(2πx)+0.08 cos(4πx) Exp. 4

In each of the above expressions, w(x) represents a “window function value”, and x has a value which is given by “N/the range of the window function; N=0 to n (n is a natural number)” and which is in the range between “0” and “1”, inclusive. The ratio calculation unit 307 calculates a weighted ratio of each process by, for example, multiplying the ratio of each process by a window function value of each window function selected from among Expressions (1) to (4).

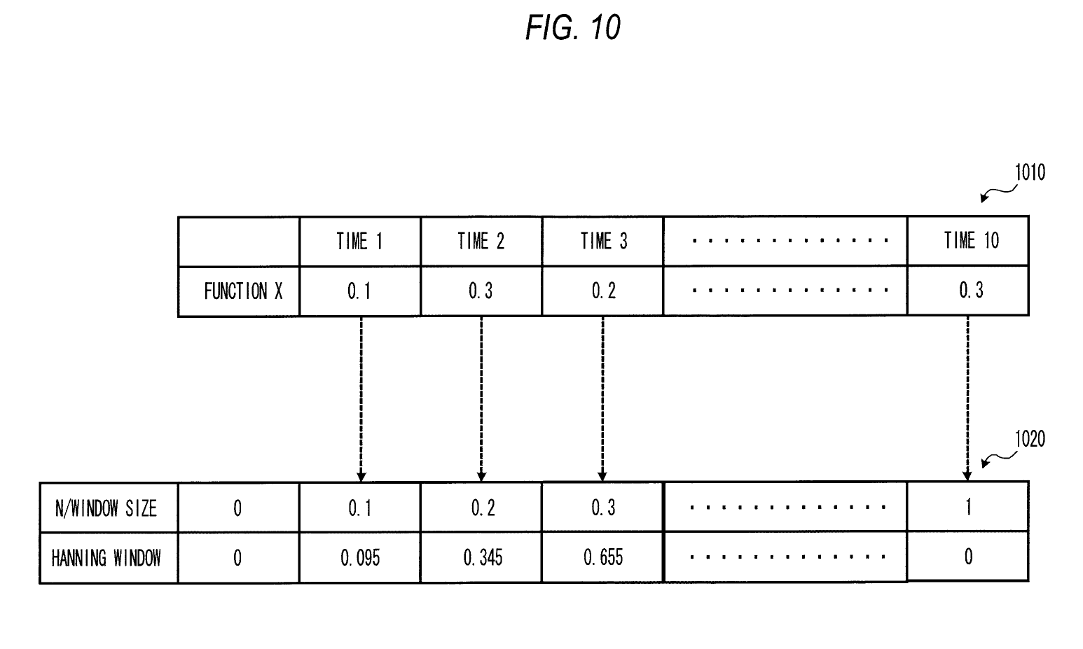

A weighting process for weighting the ratio of each process stored in the run table using those window functions will be described later with reference to FIG. 10. The weighted ratio of each process calculated by the ratio calculation unit 307 is stored in a memory such as the ROM or RAM.

The moving average calculation unit 305 has a function of calculating moving averages of weighted ratios of each process based on weighted ratios of each process calculated by the ratio calculation unit 307. Specifically, the moving average calculation unit 305 calculates moving averages of weighted ratios of each process by reading the weighted ratios of each process stored in a memory such as a ROM 502 or a RAM 503.

The display unit 303 has a function of displaying a second graph on the display screen by collecting the moving averages of weighted ratios of each process calculated by the moving average calculation unit 305. Specifically, the display unit 303 reads the moving averages of weighted ratios of each process stored in the memory such as the ROM or RAM and displays a second graph based on the moving averages on the display 131.

More specifically, the breakdown of the execution time of each process at each point in time is first calculated based on the moving averages of weighted ratios of each process. The calculated breakdown of the execution time of each process is collected to generate a second graph, and the graph is displayed by the display unit 303 on the display 131.

Specifically, the functions of the acquisition unit 301, the creation unit 302, the accepting unit 304, the moving average calculation unit 305, the selection unit 306, and the ratio calculation unit 307 are effected by the CPU, for example, through the execution of programs stored in the optical disk 111 shown in FIG. 1 or a memory such as the ROM, RAM, or HD which is not shown. The functions may alternatively be effected through the interface. The function of the display unit 303 is specifically effected by, for example, the display 131 shown in FIG. 1.

(Summary of Run Table Creating Process)

Next, a process of creating a run table representing the ratio of each process which has been executed in the computer system in a time-serial manner will be schematically described. FIG. 4 is an illustration schematically showing the run table creating process. It is assumed here that functions A, B, C, and D have been executed in the computer system.

In FIG. 4, a bar graph 410 indicates states of execution of the functions A to D represented by time series data acquired by the acquisition unit 301. Specifically, the graph shows which function is executed at which point in time. For example, the function which has been executed between points when t=3 and t=4 on the bar graph 410 is the function D.

It is assumed that one measure along the abscissa axis of the bar graph 410 represents 1 millisecond, and the predetermined unit time for indicating a time interval in which the ratio of each process is to be identified is 3 milliseconds. Therefore, points in time shown in the run table 420 are a time 1, a time 2, and so on coming each time the predetermined unit time or 3 milliseconds pass.

Specifically, the ratio of the number of runs of each function executed when t=0 to 3 in the bar graph 410 (410-1 in FIG. 4) is shown in the column of time 1 in the run table 420. The ratio of the number of runs of each function executed when t=3 to 6 in the bar graph 410 (410-2 in FIG. 4) is shown in the column of time 2.

The creation unit 302 calculates the ratio of the number of runs of each function at each point in time based on the number of runs of each function relative to the total number of functions executed in a predetermined time unit. Specifically, the ratio of the number of runs of each function at the time 1 is calculated by dividing the number of runs of each function executed when t=0 to 3 (410-1 in FIG. 4) by the total number of functions executed in the period.

The total number of runs of functions executed in the period when t=0 to 3 (410-1 in FIG. 4) is 3, and the numbers of runs of the functions A, B, C, and D are 2, 1, 0, and 0, respectively. Therefore, the ratio of the number of runs of the function A at the time 1 in the run table 420 is “⅔” (which is expressed as “0.67” in FIG. 4), and the ratio of the number of runs of the function B is “⅓” (which is expressed as “0.33” in FIG. 4). The ratio of the number of runs of the functions C and D is “0”.

Thus, the creation unit 302 calculates the ratio of the number of runs of each function at each of the times 1, 2, and so on (at each unit time) and creates the run table 420 in which results of the calculation are stored. While the predetermined unit time is 3 milliseconds in this case, the unit time may be arbitrarily set by a user, and any statistical variation can be adjusted by changing the predetermined unit time.

### SPECIFIC EXAMPLES OF THE FIRST GRAPH

Specific examples of the first graph displayed by the display unit 303 will now be described. FIG. 5 contains illustrations showing specific examples of the first graph. The first graph is a graph generated using the ratio of the number of runs of each function stored in a run table (e.g., the run table 420).

Specifically, the breakdown of execution time of each function at each point in time (e.g., the time 1, time 2, or the like) is calculated from the ratio of the number of runs of the function stored in the run table. The breakdown of the execution time of each function is the ratio of the execution time of the function executed at each point in time or within a predetermined unit time.

For example, referring to the breakdown of the execution time of each function at time 1 in the run table 420, the functions A, B, C, and D are at ratios of 67%, 33%, 0%, and 0%, respectively. The breakdown of the execution time of each function at each point in time thus calculated is sorted to plot the functions in the order of their shares in the execution time breakdown, whereby a first graph is generated.

Referring to FIG. 5, the abscissa axes of graphs 500-1 and 500-2 represent elapsed time [t], and the ordinate axes represent shares of execution times [%]. The graph 500-1 is a first graph which is based on time series data in units of 10 samples each. Specifically, the first graph is generated by collecting time series data in units of 10 samples.

The graph 500-2 is a first graph which is based on time series data in units of 100 samples each. Specifically, the first graph is generated by collecting time series data in units of 100 samples.

In each of the graphs 500-1 and 500-2, a breakdown of execution times of functions at each point in time is represented by various types of hatching. In the breakdown in each of the graphs 500-1 and 500-2, execution times of the same function are represented by the same type of hatching. In each of the graphs 500-1 and 500-2, a breakdown of execution times of ten functions having largest shares among a plurality of functions executed in the computer system is shown, the functions being shown in the order of magnitudes of their shares.

Therefore, each of the graphs 500-1 and 500-2 does not show a breakdown of execution times of functions other than the ten functions, and blanks in the graphs 500-1 and 500-2 represent such functions. The sample size of time series data for generating the first graph may be arbitrarily set, and the same is true for the number of functions to be displayed on the first graph to show the execution time breakdown thereof.

In particular, the sample size required for tracing the behavior of a program accurately or the optimum unit time for collecting time series data must be found by a user through trials and errors because it depends on the nature and situation of the program of interest.

Let us now focus on the region indicated by a circle 510 in a dotted line in the graph 500-1. The breakdown of the execution time of each function is represented in an exaggerated manner in the region, and it is difficult to trace the behavior of the program which has been executed in the computer system accurately.

Let us now focus on the region indicated by a circle 520 in a dotted line in the graph 500-2. The breakdown of the execution time of each function is represented in a gentle manner in the region, and it is difficult to trace the behavior of the program which has been executed in the computer system in detail.

As thus described, the graphs 500-1 and 500-2 appear significantly differently from each other because of the use of different sample sizes. Although the sample size (unit time) required for accurate tracing of the behavior of a program is to be found by a user through trials and errors as described above, finding an optimum sample size is a difficult task which is troublesome and time-consuming for a user.

Under the circumstance, weighting and moving averaging are used for each item of data in order to suppress variation attributable to the use of different sample sizes (different units for collecting samples). Each item of data may be weighted under various conditions to allow a graph to be displayed in various ways.

This approach is based on the fact that it is difficult to automatically find the best way of displaying a graph to allow the behavior of a program to be accurately traced because it depends on the nature of the program of interest. In this embodiment, decisions on the use of weighting and the input of optimum conditions are left to a user's hand, and support is provided to the user's efforts toward the decisions through trial and errors, whereby the ease of performance analysis of the computer system is improved.

(Display Screen of Display 131)

Display screens displayed on the display 131 will now be described. FIG. 6 is an illustration showing an example of a display change instruction screen. Referring to FIG. 6, a display instruction screen 600 shows the graph 500-2 which is a first graph. When a cursor 601 is moved to click on a Yes button 602 on the display instruction screen 600, the next screen appears (see FIG. 7).

Specifically, when the user judges that the behavior of a program which has been executed in the computer system cannot be accurately traced by the way the graph 500-2 is represented, a display change instruction for changing the graphical representation is input. The graph 500-2 may alternatively be kept displayed by moving the cursor 601 to click on a No button 603.

FIG. 7 is an illustration showing an example of a calculation type selection screen. When a cursor 701 is moved to click on a moving average button 710 on a calculation type selection screen 700, moving averages of ratios of each function stored in the run table are calculated. The moving averages are collected to display a second graph showing the ratios of a series of processes which have been executed in the computer system in a time-serial manner on the display 131.

When the cursor 701 is moved to click on a weighting button 720, the screen changes to a condition specifying screen for selecting a window function for weighting the ratio of each function stored in the run table. The condition specifying screen will be described later with reference to FIG. 11.

(Summary of Moving Average Calculation Process)

A schematic description will now be made on a process of calculating moving averages of the ratio of each function stored in the run table. FIG. 8 is an illustration schematically showing the moving average calculation process. For example, the moving averages are calculated by the moving average calculation unit 305 when the moving average button 710 is clicked on the calculation type selection screen 700 (see FIG. 7).

Referring to FIG. 8, a run table 810 shows ratios of the function A at points in time ( . . . , h, i, j, . . . ). As described above, a ratio of the function A is the ratio of number of runs of the function A to the total number of functions executed in a predetermined unit time. Moving averages of the ratios of the function A at points in time ( . . . , i, j, k, . . . ) are stored in a run table 820.

A moving average of the ratio of the function A at a certain point in time is calculated from the ratio of the function A at the time of interest, the ratio of the function A at the point in time immediately preceding the time of interest, and the ratio of the function A at the point in time immediately following the time of interest. Specifically, a moving average of the ratio of the function A at the time i is calculated from the ratios of the function A at the times h, i, and j, for example.

More specifically, a moving average of the ratio of the function A at the time i is an average of the ratios of the function A at times h, i, and j. That is, “the moving average=(0.67+0+0.33)÷3=0.33)”. The moving average of the ratio of the function A at the time j is an average of the ratios of the function A at times i, j, and k. That is, “the moving average=(0+0.33+0.67)÷3=0.33)”.

A moving average of the ratio of the function A at the time k is an average of the ratios of the function A at times j, k, and 1. That is, “the moving average=(0.33+0.67+0.33)÷3=0.44)”. Although a moving average of the ratio of the function A at each point in time is calculated by averaging ratios of the function A at three points in time, i.e., the point in time of interest and the points in time immediately preceding and following the same in this case, the range of averaging may be arbitrarily set.

### Specific Example (Example 1) of Second Graph

A specific example (Example 1) of the second graph displayed by the display unit 303 will now be described. FIG. 9 is an illustration showing a specific example (Example 1) of the second graph. The second graph described here is a graph which is generated using a moving average of the ratio of each function at each point in time and which is displayed on the display 131, for example, when the moving average button 710 is clicked on the calculation type selection screen 700 (see FIG. 7).

Specifically, a breakdown of the execution time of each function at each point in time is calculated from a moving average of the ratio of the function at the point in time. The breakdown of the execution time of each function at each point in time thus calculated is sorted to plot the functions, for example, in the order of magnitudes of their shares in the execution time breakdown, whereby the second graph is generated.

Referring to FIG. 9, the abscissa axis of a graph 900 represents elapsed time [t], and the ordinate axis represents a breakdown of execution times [%]. The graph 900 is a graph generated based on moving averages of the ratio of each function from which the graph 500-2 shown in FIG. 5 was created.

Let us now focus on the region of the graph 900 indicated by a circle 910 in a dotted line. Then, it will be understood that variation in representation attributable to the use of different sample sizes is successfully suppressed in the region when compared to the region in the circle 520 in a dotted line shown in FIG. 5 and that the behavior of a program which has been executed in the computer system can therefore be traced more easily.

However, when moving averaging is simply applied, for example, in a situation where a certain function is sampled a great number of times at a certain point in time, the function appears as if it were executed consecutively. Under such a circumstance, the ratio of each function may be weighted to show the characteristics of a program which has been executed in the computer system more clearly.

(Summary of Weighting Process)

The weighting process for weighting the ratio of each function will now be schematically described. FIG. 10 is an illustration schematically showing the weighting process. The description will address a case wherein a Hanning window is selected as a window function by which the ratio of a function is to be multiplied.

Referring to FIG. 10, ratios of a function X at points in time 1, 2, 3, . . . , 10 are stored in a run table 1010. The ratio calculation unit 307 multiplies the ratios of the function X at those points in time stored in the run table 1010 by the Hanning window that is a window function to calculate weighted ratios of the function X at the points in time.

First, the range over which the ratios of the function X are to be multiplied by the window function (window size) is decided. It is assumed here that the window size is equal to the sample size 111011 for the time series data. Next, values of the window function (Hanning window) for each window size (hereinafter referred to as “window function values”) are calculated.

Specifically, “1×=N/window size (N=0, 1, 2, 10)” is substituted in Expression (2) of the Hanning window to serve as a window function, whereby window function values for each window size are calculated. For example, when N=1, x= 1/10. When the value is substituted in Expression (2), a window function value w(x)=0.095 is calculated.

Window function values for each window size are calculated as thus described, and results of the calculations are stored in a window function value table 1020. Thus, window function values for the window size used when a Hanning window is selected as a window function are stored in the window function value table 1020.

The ratio of the function X at each point in time stored in the run table 1010 is multiplied by the respective window function value stored in the window function value table 1020 to calculate a weighted ratio of the function X at each point in time.

Specifically, as indicated by dotted lines in FIG. 10, the ratio “0.1” of the function X at the time 1 is multiplied by the window function value “0.095” to calculate a weighted ratio “0.0095” of the function X at the time 1. A weighted ratio of the function X at each point in time calculated by the ratio calculation unit 307 as thus described is stored in a memory such as the ROM or RAM.

Although the above description refers only to the function X, the above-described weighting process is performed on each of a plurality of functions executed in the computer system to calculate a weighted ratio of each function at each point in time. Results of the calculations are stored in a memory such as the ROM or RAM in association with the respective functions.

### Specific Example of Condition Specifying Screen

A specific example of the condition specifying screen displayed on the display 131 will now be described. FIG. 11 is an illustration showing an example of the condition specifying screen. Drawing specifications made to generate a second graph will be described here. A cursor 1101 is moved on a condition specifying screen 1100 to click each box, which allows various conditions for weighting the ratio of each function to be input.

For example, when the cursor 1101 is moved to click on a drawing interval box 1110, a drawing interval can be input. A drawing interval is a time interval during which a breakdown of the execution time of each function is plotted on the second graph.

When a drawing interval is to be specified as the ratio of the same to the window size or to be specified as a sample size, the cursor 1101 is moved to click on a button 1111 or a button 1112, respectively. Thereafter, the cursor 1101 is moved to click on the drawing interval box 1110, and a drawing interval is then input.

A range over which the ratio of each function is to be multiplied by a window function can be input by moving the cursor 1101 to click on a window size box 1120. When a window size is to be specified as the ratio of the same to the drawing interval or to be specified as a sample size, the cursor 1101 is moved to click on a button 1121 or a button 1122, respectively. Thereafter, the cursor 1101 is moved to click on the drawing interval box 1110, and a window size is then input.

A window function for weighting the ratio of each function can be selected from among a plurality of window functions by moving the cursor 1101 to click on a window function box 1130. In this case, a window function for weighting the ratio of each function can be selected from among a rectangular window, a triangular window, a Hanning window, a Hamming window, and a Blackman window.

When the input of the various conditions is completed, the cursor 1101 is moved to click on a graph display button 1041. Then, a second graph is generated based on the input conditions and displayed on the display 131. When a cancel button 1142 is clicked, the calculation type selection screen (see FIG. 7) appears again.

In addition to drawing specifications, conditions such as object specifications, time specifications, data specifications, and graph types can be input. Referring to object specifications, when a plurality of CPUs are incorporated in the computer system, specifications can be made such that data of execution time breakdown will be collected for functions executed by each CPU or functions executed only by a particular CPU.

In the case of a cluster system, object specifications can be made such that data of execution time breakdown can be collected for any of functions executed by the entire cluster system, functions executed by each of the computers forming the cluster system, and functions executed by any particular computer (s), which makes it possible to trace behaviors of programs that take place between computers accurately.

Referring to time specifications, a time slot in which data are to be collected can be specified out of the entire time period under measurement. Such a way of specifying time allows the use of a scheme having a first step for roughly tracing the behavior of the computer system as a whole to predict a problematic time slot to some extent and a subsequent step for checking the time slot in detail.

Referring to data specifications, in addition to functions, processes and objects can be specified to be drawn on a graph to show execution time breakdown thereof. Referring to graph types, a graph such as a bar graph or an area graph may be specified as a form of display of a second graph.

When a graph display button 1141 is clicked after various conditions are input on the condition specifying screen 1100 as thus described, a second graph is generated based on the input conditions and displayed on the display 131. Specifically, window function values based on the specified window size are first calculated.

Then, the ratio of each function is multiplied by each of the window function values thus calculated to calculate weighted ratios of each function. Thereafter, moving averages of the weighted ratios of each function are calculated, and a second graph is generated based on the moving averages and displayed on the display 131.

When the ratio of each function is weighted, the behavior of the same program can appear differently depending on the window function by which the ratio is multiplied, and the behavior can appear differently depending on the nature of the program of interest. The behavior of a program can also appear differently depending on the range over which the ratio is multiplied by a window function (window size).

The user operates on the condition specifying screen 1100 to input various conditions, whereby a second graph based on the conditions is displayed. This series of operations is repeated to find a second graph which allows the behavior of a program executed in the computer system to be accurately traced.

### Specific Example (Example 2) of Second Graph

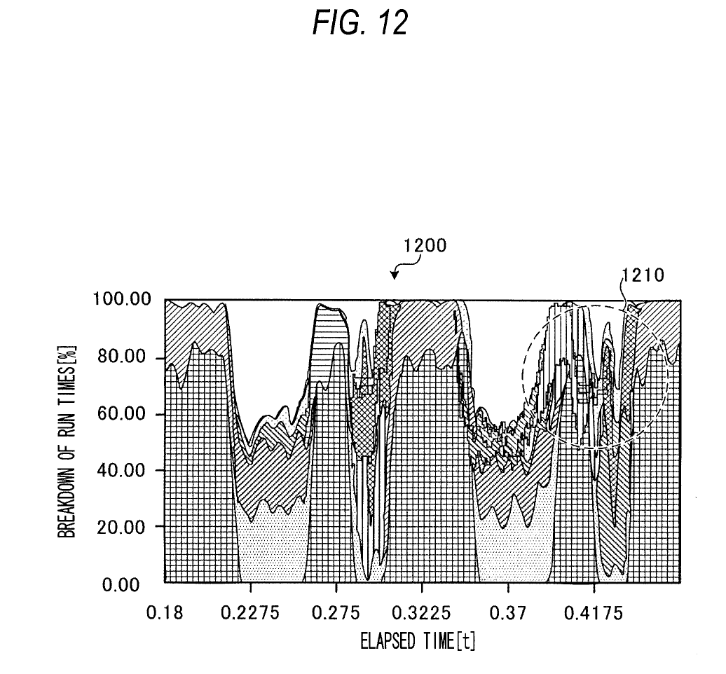

A description will now be made on the second graph displayed on the display 131 by the display unit 303 as a result of the input of various conditions as described above. FIGS. 12 to 14 are illustrations showing specific examples of the second graph. The second graph is a graph generated using moving averages of weighted ratios of each function at each point in time.

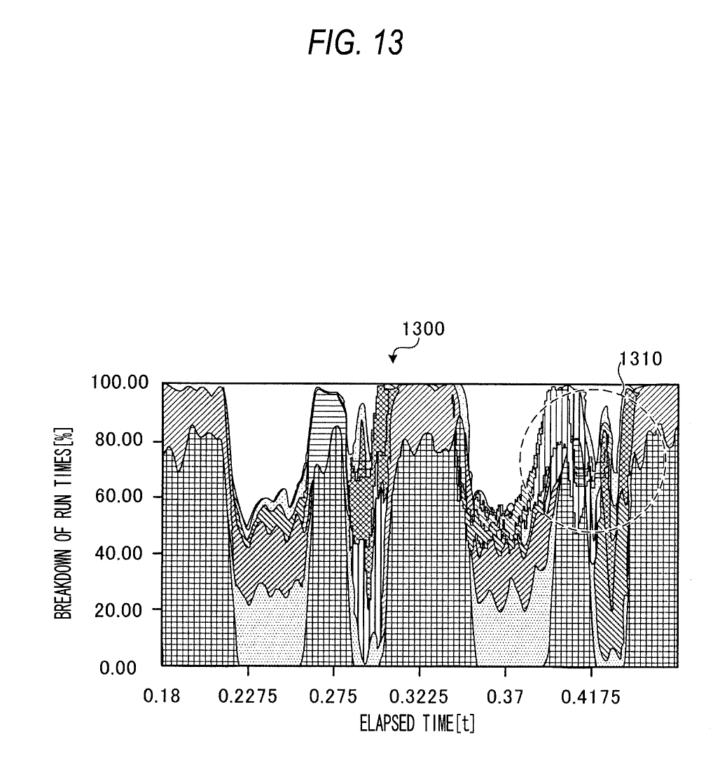

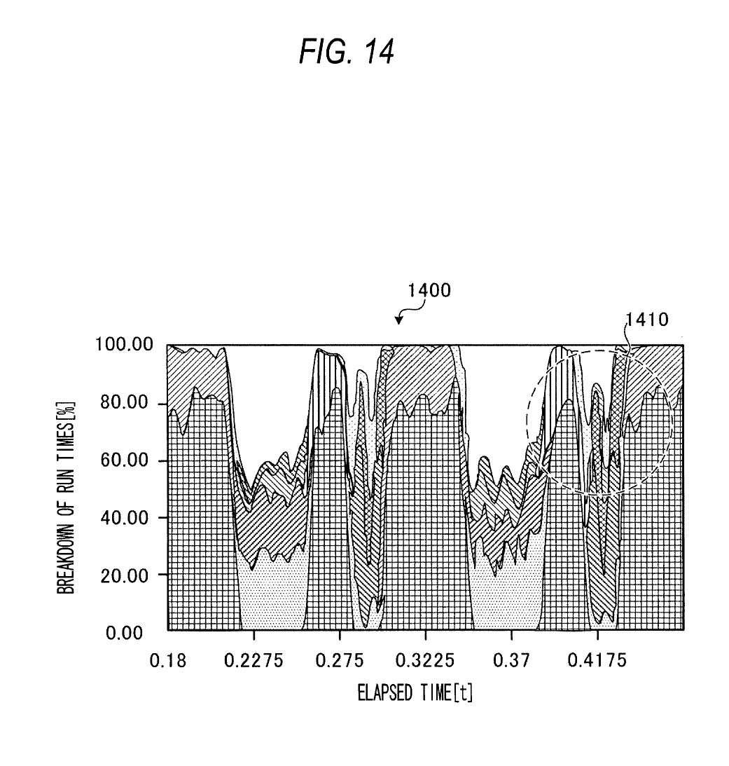

The second graphs shown in FIGS. 12 to 14 are graphs generated by multiplying every ten samples as a window size by a window function to calculate moving averages of 200 samples. FIG. 12 shows an example in which a triangular window is selected as the window function. FIG. 13 shows an example in which a Hamming window is selected as the window function. FIG. 14 shows an example in which a Blackman window is selected as the window function.

Let us now focus on the region of a graph 1200 indicated by a circle 1210 in a dotted line in FIG. 12. Then, it will be understood that a curve indicating a breakdown of the execution time of each function is gently represented and that characteristics of the execution time breakdown of the function are clearly shown.

Referring to the region of a graph 1300 indicated by a circle 1310 in a dotted line in FIG. 13 and the region of a graph 1400 indicated by a circle 1410 in a dotted line in FIG. 14, it will be similarly understood that curves indicating a breakdown of the execution time of each function are gently represented and that characteristics of the execution time breakdown of the function are clearly shown.

As thus described, a user can efficiently find optimum conditions by repeating simple input operations. Thus, a graph allowing accurate tracing of the behavior of a program can be presented to the user, and it is therefore possible to improve the efficiency of an operation of identifying problems such as troubles and degradation of performance in the computer system.

(Steps of System Analyzing Process of System Analysis Apparatus)

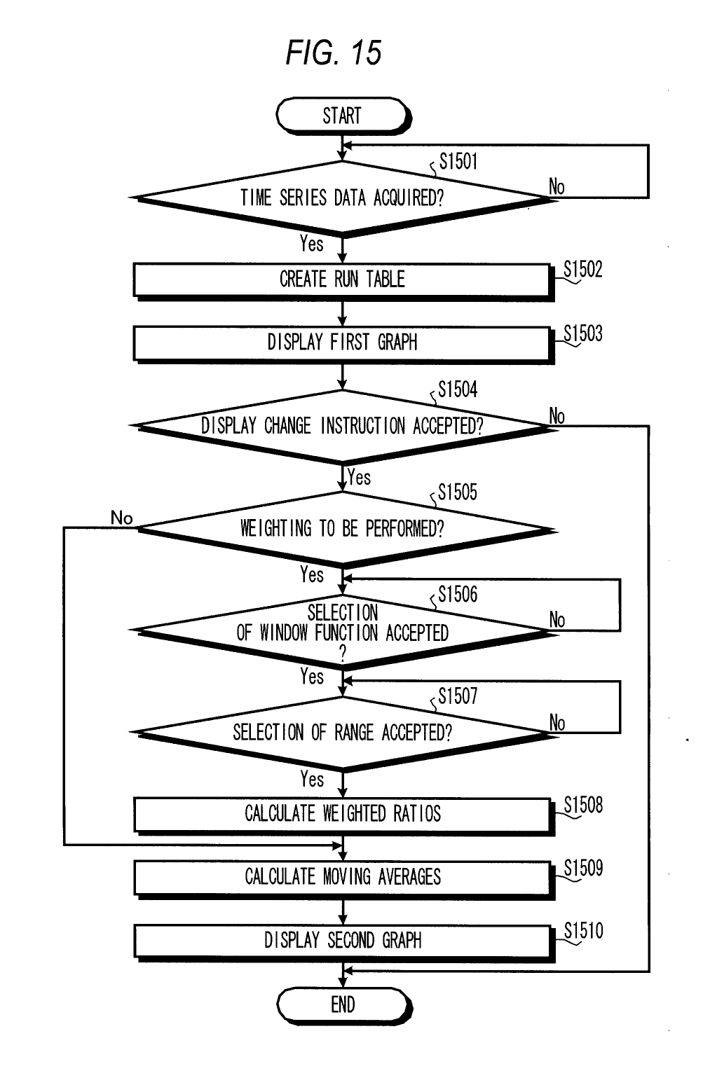

Steps of a system analyzing process performed by the system analysis apparatus 100 of the present embodiment of the invention will now be described. FIG. 15 is a flow chart showing steps of a system analyzing process of the system analysis apparatus 100 of the present embodiment.

Referring to FIG. 15, it is first determined whether the acquisition unit 301 has acquired time series data representing information on a series of processes which have been executed in the computer system in a time-serial manner (step S1501).

The procedure waits until time series data are acquired (step S1501: No). When the data are acquired (step S1501: Yes), the creation unit 302 creates a run table showing the ratio of the number of runs of each process to the total number of runs of processes executed in a predetermined unit time in a time-serial manner (step S1502).

Thereafter, the display unit 303 collects such ratios of each process stored in the run table created by the creation unit 302 and displays a first graph showing ratios of the series of processes which have been executed in the computer system in a time-serial manner (step S1503).

Next, when the first graph is displayed by the display unit 303, it is determined whether the accepting unit 304 has accepted a display change instruction for the first graph or not (step S1504). When a display change instruction for the first graph has been accepted (step S1504: Yes), it is determined whether the selection unit 306 has accepted selection to weight the ratio of each process or not (step S1505).

When it is determined at step S1504 that no display change instruction for the first graph has been accepted (step S1504: No), the series of processes according to this flowchart is terminated.

When it is determined at step S1505 that the selection to weight the ratio of each process has been accepted (step S1505: Yes), it is determined whether the selection unit 306 has accepted selection of a window function for weighting the ratio of each process from among a plurality of window functions or not (step S1506).

The procedure waits until the selection of a window function is accepted (step S1506: No). When the selection is accepted (step S1506: Yes), it is determined whether selection of a range over which the ratio of each process are to be multiplied by the selected window function has been accepted by the selection unit 306 or not (step S1507).

The procedure waits until the selection of a range for the multiplication by the window function is accepted (step S1507: No). When the selection is accepted (step S1507: Yes), the ratio calculation unit 307 multiplies the ratio of each process by the window function based on the selected range to calculate weighted ratios of each process (step S1508).

Thereafter, the moving average calculation unit 305 calculates moving averages of the weighted ratios of each process based on the weighted ratios of each process calculated at step S1508 (step S1509).

Finally, the display unit 303 collects the moving averages of the weighted ratios of each process calculated by the moving average calculation unit 305 to display a second graph (step S1510), and the series of processes according to the flow chart is terminated.

When it is determined at step S1505 that the selection to weight the ratio of each process has not been accepted (step S1505: No), the moving average calculation unit 305 calculates moving averages of the ratio of each process by referring to the run table created by the creation unit 302 at step S1502 (step S1509).

Finally, the display unit 303 collects the moving averages of each process calculated by the moving average calculation unit 305 to display a second graph showing ratios of the series of processes which have been executed in the computer system in a time-serial manner (step S1510), and the series of processes according to the flow chart is terminated.

As thus described, the system analysis apparatus 100 of the present embodiment of the invention can present graphs in which variation attributable to the use of different units for collecting time series data (e.g., sample sizes) is suppressed. Further, since the ratio of each process is weighted, it is possible to present a graph properly representing characteristics of the behavior of a program which has operated in the computer system.

As described above, according to the invention, a second graph is generated based on moving averages of the ratio of each process which has been executed in the computer system. It is therefore possible to present graphs in which variation attributable to the use of different units for collecting time series data is suppressed.

Since the ratio of each process executed in the computer system is weighted, it is possible to present graphs properly representing characteristics of the behavior of a program.

The invention is advantageous in that a GUI capable of presenting graphs representing the behavior of a program in a simple and accurate manner can be provided to improve the efficiency of performance analysis on a computer system.

The system analysis method described in the present embodiment may be implemented by executing a program prepared in advance on a computer such as a personal computer or a workstation. Such a program is recorded in a computer-readable recording medium such as a hard disk, flexible disk, CD-ROM, MO, or DVD and read from the recording medium to be executed by the computer. The program may be a transferable medium which can be distributed through a network such as the internet.

The above-described system analysis apparatus 100 may be implemented in the form of an application specific integrated circuit (hereinafter simply referred to as “ASIC”) such as a standard cell or structured ASIC or a PLD (programmable logic device) such as an FPGA. Specifically, the functions of the functional units 301 to 307 of the system analysis apparatus 100 may be defined by HDL descriptions, and the system analysis apparatus 100 may be manufactured by logically synthesizing the HDL descriptions and imparting them to an ASIC or PLD.

What is claimed is:

1. A computer-readable recording medium in which a system analysis program to be executed by a computer is stored, the program comprising:
an acquisition step for acquiring time series data representing information on a series of processes which has been executed in a computer system in a time-serial manner;
a creation step for creating a run table showing the ratio of the number of runs of each process to the total number of processes executed in a predetermined unit time in a time-serial manner based on the time series data acquired in the acquisition step;
a first display step for displaying a first graph representing ratios of a series of processes which has been executed in the computer system in a time-serial manner by collecting the ratio of each process stored in the run table created at the creation step;
an accepting step for accepting a display change instruction for the first graph as a result of the display of the first graph at the first display step;
a moving average calculation step for calculating a moving average of the ratio of each process by referring to the run table created at the creation step when the display change instruction for the first graph is accepted at the accepting step; and
a second display step for displaying a second graph representing the ratios of the series of processes which has been executed in the computer system in a time-serial manner by collecting the moving average of each process calculated at the moving average calculation step.

2. A computer-readable recording medium according to claim 1, further comprising:
a first selection step for accepting selection on whether to weight the ratio of each process or not when the display change instruction for the first graph is accepted at the accepting step;
a second selection step for accepting selection of a window function for weighting the ratio of each process from among a plurality of window functions when the selection to weight the ratio of each process is accepted at the first selection step; and
a ratio calculation step for calculating a weighted ratio of each process by multiplying the ratio of each process by the window function selected at the second selection step;
wherein the moving average calculation step calculates a moving average of the weighted ratio of each process based on the weighted ratio of each process calculated at the ratio calculation step; and
the second display step displays the second graph by collecting the moving average of the weighted ratio of each process calculated at the moving average calculation step.

3. A computer-readable recording medium according to claim 2, further comprising:
a third selection step for accepting selection of a range over which the ratio of each process is to be multiplied by the window function selected at the second selection step, wherein the ratio calculation step calculates a weighted ratio of each process by multiplying the ratio of each process by the window function based on the range selected at the third selection step.

4. A computer-readable recording medium according to claim 2, wherein the window function is a triangular window.

5. A computer-readable recording medium according to claim 2, wherein the window function is a Hanning window.

6. A computer-readable recording medium according to claim 2, wherein the window function is a Hamming window.

7. A computer-readable recording medium according to claim 2, wherein the window function is a Blackman window.

8. A system analysis method executed by a computer, comprising:
an acquisition step for acquiring time series data representing information on a series of processes which has been executed in a computer system in a time-serial manner;
a creation step for creating a run table showing the ratio of the number of runs of each process to the total number of processes executed in a predetermined unit time in a time-serial manner based on the time series data acquired in the acquisition step;
a first display step for displaying a first graph representing ratios of a series of processes which has been executed in the computer system in a time-serial manner by collecting the ratio of each process stored in the run table created at the creation step;
an accepting step for accepting a display change instruction for the first graph as a result of the display of the first graph at the first display step;
a moving average calculation step for calculating a moving average of the ratio of each process by referring to the run table created at the creation step when the display change instruction for the first graph is accepted at the accepting step; and
a second display step for displaying a second graph representing the ratios of the series of processes which has been executed in the computer system in a time-serial manner by collecting the moving average of each process calculated at the moving average calculation step.

9. A system analysis apparatus comprising:
an acquisition unit for acquiring time series data representing information on a series of processes which has been executed in a computer system in a time-serial manner;
a creation unit for creating a run table showing the ratio of the number of runs of each process to the total number of processes executed in a predetermined unit time in a time-serial manner based on the time series data acquired in the acquisition step;
a display unit for displaying on a display screen a first graph representing ratios of a series of processes which has been executed in the computer system in a time-serial manner by collecting the ratio of each process stored in the run table created by the creation unit;
an accepting unit for accepting a display change instruction for the first graph as a result of the display of the first graph by the display unit; and
a moving average calculation unit for calculating a moving average of the ratio of each process by referring to the run table created by the creation unit when the display change instruction for the first graph is accepted by the accepting unit, wherein the display unit displays on the display screen a second graph representing the ratios of the series of processes which has been executed in the computer system in a time-serial manner by collecting the moving average of each process calculated by the moving average calculation unit.
